(19) United States
(12) Patent Application Publication
(10) Pub. No.: US 2005/0226320 A1
(43) Pub. Date: Oct. 13, 2005

(54) Circuit, apparatus and method for storing audiovisual data

(75) Inventors: Nicolaas Lambert, Eindhoven (NL); Renatus Josephus Van der Vleuten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/511,803

(22) PCT Filed: Apr. 22, 2003
(86) PCT No.: PCT/IB03/01579

§ 371 Date: Oct. 19, 2004

(30) Foreign Application Priority Data
Apr. 22, 2002 (EP) 02076559.0

(51) Int. Cl. H04N 7/12

(52) U.S. Cl. 375/240.02

(57) ABSTRACT

Bit-rate scalable compression for storing A/V information in a pause buffer of a digital video recorder, providing a viewer of a live program to take a delayed decision about whether or not to record the program while still viewing the “live” program at full quality, i.e. at a higher quality than the quality at which it will be stored, whereby only the “enhancement layers” need to be stored in the buffer, whereby since the bit rate of these layers is significantly lower than the bit rate for the complete compressed data, the capacity (minutes of recording time) of the buffer is significantly increased.

The present invention relates to a circuit for storing audiovisual data.

The present invention also relates to an apparatus for storing audiovisual data.

The present invention also relates to a method for storing audiovisual data in a memory.

When viewing pre-recorded programs, a viewer can stop a program temporarily, for instance to “pause” and view the program later.

Furthermore, live television transmissions can be continuously recorded in a buffer memory typically provided in a recorder and a history is maintained as far back as the extent of the buffer memory will permit. Typically, the buffer memory continually stores incoming data, writing over the oldest data for subsequent storing on a main memory, so that a fixed “time window” of prior recorded data are present in the memory buffer. The recorded data can also be continuously read from the buffer memory and supplied to a display unit. This is described for instance in U.S. Pat. No. 5,371,551.

Furthermore, a viewer may decide after watching a program for ten minutes that it is worth recording onto video and then retrospectively start video recording, while continuing to watch the program live. This can also be provided by a buffer memory and is described in EP-A1-0 594 241.

In IEEE Transactions on circuits and systems for video technology, Vol. 11, No. 3, March 2001, it is described a capability to distribute single-layered frame-based video over a wide-range of bit-rates with high coding efficiency.

However, there is still a demand to increase data storage capacity of a buffer memory without degradation of the quality of data, typically (audio/video) A/V information during replay and/or to improve storage at different bit-rates.

It is an object of the invention to provide a buffer, having increased capacity and/or improved storage at different bit-rates.

According to a first aspect of the present invention, the object is realised by using bit-rate scalable compression for storing A/V information in a pause buffer of a recorder or connectable to the same.

Herein, the term “bit-rate scalable compression” means that the bit-rate is scalable.

According to a second aspect of the invention, the A/V information is compressed in layers, typically in enhancement layer(s) and basic layer(s), which are stored in different memories, of which one is the buffer.

According to a preferred embodiment of the invention, there is provided Circuit for storing audiovisual data, said circuit being connectable to a main memory, said circuit comprising an input for receiving data and an output for distributing data stored in the main memory, wherein the circuit comprises a data compression processor coupled to the input to compress the received data in layers by means of bit-rate scalable compression and an auxiliary memory, coupled to the data compression compressor for storing one or more enhancement layer, wherein the circuit is further adapted to store one or more basic layers in the main memory.

Preferably, the apparatus is arranged to compress the data in a wide range of bit-rates and/or compressions.

Preferably, the apparatus comprises a FIFO buffer or a reversible queue mechanism.

According to another preferred embodiment of the invention, there is provided an apparatus for storing audiovisual data, said apparatus comprising the circuit according to the invention, an input terminal for receiving the data, coupled to the input of the circuit, an output terminal for supplying a delayed version of the data, coupled to the output of the circuit and a main memory coupled to the output of the circuit and to the output terminal of the apparatus.

According to another preferred embodiment of the invention, there is provided a method for storing audiovisual data in a memory, said method comprising the steps of receiving data, compressing the data by means of bit-rate scalable compression to at least one basic layer and at least one enhancement layer and storing the enhancement layer in an auxiliary memory, and the basic layer in a main memory.

These and other aspects and embodiments of the invention will be apparent from and elucidated with reference to the embodiments(s) described hereinafter.

The present invention will be more clearly understood from the following description of the preferred embodiments of the invention read in conjunction with the attached drawings, in which:

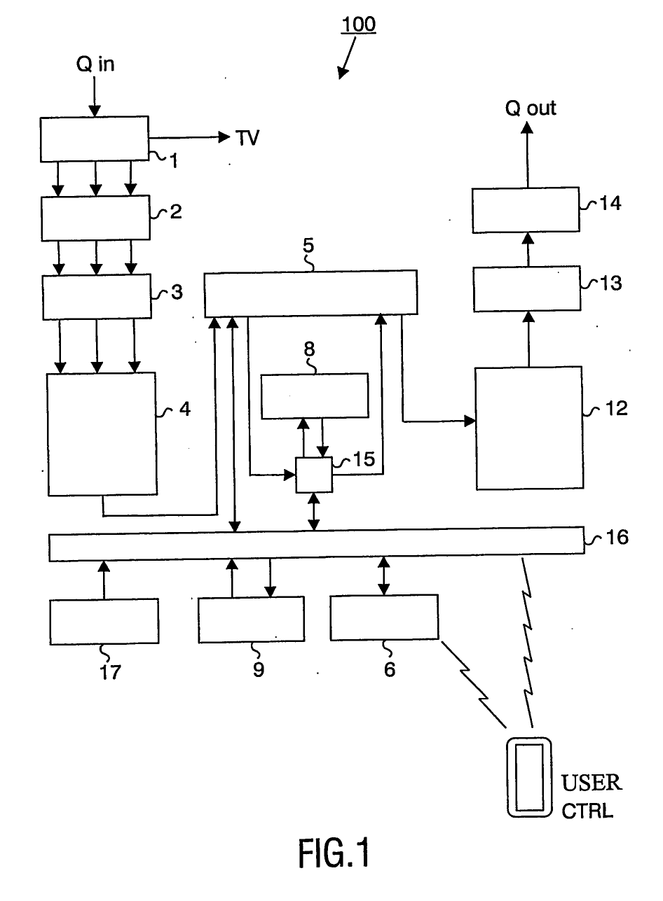

FIG. 1 illustrates a preferred embodiment of a circuit comprising a buffer memory according to the invention.

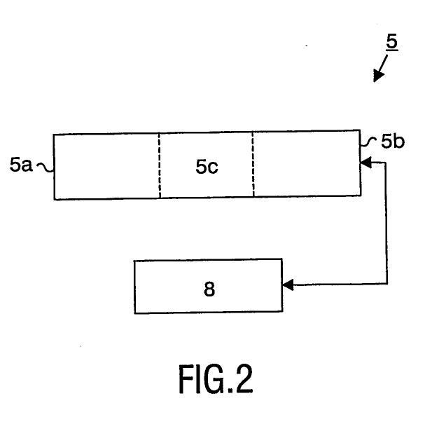

FIG. 2 illustrates the buffer memory in more detail and the operation principle thereof.

The invention will now be described by preferred embodiments in conjunction with accompanying drawing figures.

FIG. 1 illustrates an embodiment of a circuit 100 according to a preferred embodiment of the invention. One or more signals Qin (in this case television signals) first pass through a channel selector 1, which selects which signals, according to their channel, are to be stored, and which signals, according to their channel, are required for live display on a TV set. The signals Qin, which are to be stored are digitized to digital data by means of an A/D (analogue to digital) converter 2. Of course, this converter 2 can be omitted if the signal is already a digital one. The digital data is then compressed in real time by a data compressor 3. The output of each channel after being compressed by the data compressor 3 is placed in a buffer 4, of which there is at least one per selected channel. The information contained in the buffer 4 will be transferred to a buffer memory 5 under supervision of a microprocessor 6 for instance by a DMA (direct memory access) controller (not shown). From the buffer memory 5 the information will be transferred to a main memory 8, which can be in the form of a band disk arrangement, a hard disk or a high capacity non-volatile solid state memory such as a ferro-electric polymer memory. The main memory 8 is connected to the circuit 100 and not necessarily comprised in the circuit 100. The main memory 8 is used for storing desired portions of the compressed video from the buffer memory 5, or for playing back the stored portions via the buffer memory 5. The main memory 8 can also be a complete digital videocassette recorder (VCR) of conventional type. The microprocessor 6 initiates the data transfer from the buffer 4 to the buffer memory 5, and performs memory allocation and control in the buffer memory 5. Other types of control circuitry than microprocessor control can also be employed, but is not further disclosed, since such solutions are obvious for a person skilled in the art to arrive at, without departing from the invention. To expand the capacity and increase the performance of the buffer memory 5, the compressor 3 is provided for “compressing” the data, in this case a video signal before being written into the buffer memory 5. The compression format is of a bit-rate scalable type, which will be described in more detail below by reference to FIG. 2. It is also possible to provide the processor 3 inside the buffer memory 5 or after the buffer 4, or to provide more than one compressors, depending on requirement. The buffer memory 5 preferably has a capacity of comprising at least thirty minutes of compressed video. The microprocessor 6 runs ROM (read-only memory) 17 based software and makes use of a working RAM (random access memory) 9 for temporary variables, the administration of the buffer memory 5, storage of user commands etc. Input data in the buffer memory 5 is transferred to the main memory 8 as soon as it is convenient under supervision of the microprocessor 6 for instance by a DMA controller 15.

The stored data in main memory 8 is in due course transferred to the buffer memory 5 under supervision of the microprocessor 6 for instance by the DMA controller 15. As television data is actually required to be displayed by the TV set, it is transferred under supervision of the microprocessor 6 typically by a DMA controller (not shown) to a buffer 12. All signaling from and to ROM, RAM and microprocessor 6 can be handled by a data bus 16.

Data is taken from the buffer 12, decompressed by a data decompressor 13, and converted to an analogue signal by a d/a (digital to analogue) converter 14. The output of the D/A converter 14 can be sent to a TV set or an analogue VCR.

Referring now to FIG. 2, illustrating an apparatus for temporarily storing data (corresponding to the buffer memory 5), the operation principle thereof will be described in more detail.

Data arrives at an input of the buffer memory 5 for storage therein. As soon as the main memory 8 is capable of receiving the data, the data first stored in an input buffer 5a of the buffer memory, is supplied to an output buffer 5b of the buffer memory 5 and applied to the main memory 8 for storage. The input and output buffers 5a and 5b, can be contained in the input and output of the buffer memory 5, which input 5a and output 5b therefore will have the same reference numeral as the corresponding buffers. Typically, the buffer memory 5 stores incoming data, so that a fixed duration of prior recorded data is continuously read from the buffer memory 5.

Data will also be regularly requested from the main memory 8 to be displayed by a TV set or recorded by an analogue VCR etc. As soon as the main memory 8 is capable of supplying data, the data stored in the main memory 8, is supplied to the buffer memory 5, for storage in the output buffer 5b thereof. It may also be possible to supply data directly from the main memory 8 without using the output buffer 5b of the buffer memory 5.

Preferably, the input buffer 5a and the output buffer 5b are combined into one shared buffer memory 5, or alternatively the buffer memory 5 does not comprise input and output buffers 5a and 5b. The input buffer part and the output buffer part in the buffer memory can be realized for instance using a FIFO or alternatively a reversible queue mechanism.

A basic administration of the buffer memory 5 is possible using 3 FIFO queues, namely one FIFO queue for the free memory blocks 5c in the buffer memory 5, one FIFO for the input buffer memory part 5a in the buffer memory 5 and one FIFO for the output buffer memory part Sb of the buffer memory 5.

The FIFO queue control blocks, such as a control block, can be located in fixed locations of working RAM 6 or the buffer memory 5.

Preferably the buffer memory 5 is a time shift buffer provided with means for bit-rate scalable compression, wherein the data is typically compressed in layers, typically in a basic layer and enhancement layer(s). Alternatively, the data has already been compressed in layers in the data compressor 4 (FIG. 1) before being sent to the buffer memory 5. The bit-rate is scalable and the data, for instance video data, is compressed. The buffer memory is arranged to provide the amount of compression, preferably in a wide range of bit-rates and/or compressions to improve the operation of the buffer memory. This can be provided since a bit-rate scalable compression method is employed according to the invention, whereby data (typically a bit-stream) comprises at least two layers of which a lower layer or lower layers can be decoded without higher layers when desired. This has several advantages, which will be described below.

In this embodiment of the invention, the compression means are comprised by the buffer. In yet another embodiment, the scalable compression is performed by a separate compression processor.

The output/result of compression (data) usually is a bit stream, but this is not a requirement, since any type of data is possible.

The data in the buffer memory 5 is scalable stored. For instance, a basic layer, stored in the main memory 8 could contain most significant bits for instance for discrete cosine transform (DCT) coefficients representing the data Remaining bits are then stored in enhancement layers in the buffer memory 5. The highest enhancement layer then contains least significant bits.

The amount of compression that is applied to the data that is stored in the buffer memory 5 can be varied by a user to allow longer programs to be recorded (with reduced quality) within the available memory space.

When watching a program, the viewer can take a delayed decision about whether or not to record the program while still viewing the “live” program at full quality, i.e. at a higher quality than the quality at which it will be stored. For example, if the buffer memory has a capacity of 20 minutes of video at the highest bit rate/quality, the user can decide to record the program going back up to 20 minutes in the past. If the user decides to store the program, the previous 20 minutes are immediately stored on the storage medium at a lower quality (the user can also take a delayed decision on the desired recording quality, since all quality levels up to the viewing quality are still available). Without scalable compression, such a delayed recording decision is either not possible, because the bit rate in the buffer memory is higher than the desired bit rate for storage, or it causes a waste of bits because the first 20 minutes will be stored at a higher quality than the rest of the program (although the bit rate of these 20 minutes could be lowered again by off-line bit rate transcoding). To efficiently enable a delayed recording decision without scalable compression, the video data would have to be stored in the pause buffer at the same bit rate at which it could be recorded. However, in that case, the quality of the “live” program is also lowered to the quality at which it is stored, thus undesirably reducing the viewing experience. (An inefficient alternative would be to store the data compressed at both the high and the low quality/bit rate, but this would significantly reduce the buffer memory capacity).

When the viewer watches a program, which is simultaneously being recorded at a lower quality, only the “enhancement layers” need to be stored in the time-shift buffer. Since the bit rate of these layers is significantly lower than the bit rate for the complete compressed data, the capacity (minutes of recording time) of the buffer is significantly increased in this case.

The circuit 100 as presented in FIG. 1 may be comprised in a consumer apparatus for storing audio-visual data in a memory like a DVD+RW recorder 300 as shown in FIG. 3. Alternatively, the circuit 100 may be comprised in a harddisk recorder.

The invention can be used to pause a video program while answering the telephone. The invention provides increased capacity of the pause buffer by compression, without degradation of the quality of the data during replay. The content of the buffer can be used for delayed recording of content in case of a delayed decision of recording.

The described embodiment assumes incoming content to be uncompressed. When the incoming content is already compressed, the incoming content will have to be transcoded to a bit-rate scalable compression format.

The present invention has been described in conjunction with a number of preferred embodiments thereof, which combines various features and various aspects of the invention. It should be understood that these features and aspects may be combined in different ways and various embodiments of the invention may include one or more aspects of the invention.

It is a principal aspect of the invention to provide bit-rate scalable compression for storing A/V information in a pause buffer of a digital video recorder.

As used in the following claims, the word “comprise” means including, but not necessarily limited to.

The invention may be summarized as follows:

Bit-rate scalable compression for storing A/V information in a pause buffer of a digital video recorder, providing a viewer of a live program to take a delayed decision about whether or not to record the program while still viewing the “live” program at full quality, i.e. at a higher quality than the quality at which it will be stored, whereby only the “enhancement layers” need to be stored in the buffer, whereby since the bit rate of these layers is significantly lower than the bit rate for the complete compressed data, the capacity (minutes of recording time) of the buffer is significantly increased.

1. Circuit for storing audiovisual data, said circuit being connectable to a main memory, said circuit comprising:
an input for receiving data; and
an output for distributing data stored in the main memory;
wherein the circuit comprises:
a data compression processor coupled to the input to compress the received data in layers by means of bit-rate scalable compression; and
an auxiliary memory, coupled to the data compression compressor for storing one or more enhancement layer; and
wherein the circuit is further adapted to store one or more basic layers in the main memory.

2. Circuit according to claim 1, wherein the auxiliary memory comprises a FIFO buffer.

3. Circuit according to claim 1, comprising a reversible queue mechanism.

4. Circuit according to claim 1, wherein the circuit is arranged to vary the amount of compression, preferably in a wide range of bit-rates and/or compressions.

5. Apparatus for storing audiovisual data, said apparatus comprising:
the circuit according to claim 1;
an input terminal for receiving the data, coupled to the input of the circuit;
an output terminal for supplying a delayed version of the data, coupled to the output of the circuit; and
a main memory coupled to the output of the circuit and to the output terminal of the apparatus.

6. Method for storing audiovisual data in a memory, said method comprising the steps of:
receiving data,
compressing the data by means of bit-rate scalable compression to at least one basic layer and at least one enhancement layer; and
storing the enhancement layer in an auxiliary memory, and the basic layer in a main memory.
